(19) United States
(12) Patent Application Publication
(10) Pub. No.: US 2024/0272910 A1
(43) Pub. Date: Aug. 15, 2024

(54) ELECTRONIC DEVICE AND OPERATION METHOD THEREOF

(71) Applicant: SigmaStar Technology Ltd., Xiamen (CN)

(72) Inventors: Qin-Wei She, Xiamen (CN); Yan-Xiong Wu, Xiamen (CN); Xiao-Min Zhang, Xiamen (CN)

(21) Appl. No.: 18/523,951

(22) Filed: Nov. 30, 2023

(30) Foreign Application Priority Data
Feb. 10, 2023 (CN) 202310107267.X

(51) Int. Cl. G06F 9/4401

(52) U.S. Cl. CPC G06F 9/4401

(57) ABSTRACT

An electronic device includes a memory and is coupled to an external storage device that stores a boot code of the electronic device. An operation method of the electronic device includes the following steps: (A) writing a first segment of the boot code into a memory block of the memory, (B) executing a part of the first segment of the boot code; and (C) executing a target code in the memory block in response to an interrupt.

This application claims the benefit of China application Serial No. 202310107267.X, filed on Feb. 10, 2023, the subject matter of which is incorporated herein by reference.

### BACKGROUND OF THE INVENTION

### 1. Field of the Invention

The present invention generally relates to an electronic device, and, more particularly, to a boot flow of the electronic device and an operation method of the electronic device.

### 2. Description of Related Art

FIG. 1 shows a schematic diagram of the boot flow of an electronic device running a Linux system. The boot flow mainly includes the following boot procedures: the read-only memory (ROM) boot 110, Miniboot 120, U-boot 130, and Kernel 140. The ROM boot, Miniboot, U-boot, and Kernel are well known to people having ordinary skill in the art, and the details are thus omitted for brevity.

The source code that needs to be protected is usually compiled into a library that is run in the Kernel 140. The library, which provides a unified external interface that other modules or third parties can call, allows the third party to use the protected source code to access resources while achieving the effect of protecting the source code.

However, as shown in FIG. 1, the Linux system must go through the ROM boot 110, Miniboot 120, and U-boot 130 before entering the Kernel 140; these procedures before the Kernel 140 inevitably take some time. Therefore, if the source code that needs to be protected can be accessed before the Linux system enters the Kernel 140, the time between the system boot and the execution of the source code that needs to be protected can be shortened, which is of great help in the development or operation of electronic products using the Linux system.

### SUMMARY OF THE INVENTION

In view of the issues of the prior art, an object of the present invention is to provide an electronic device and an operation method thereof, so as to make an improvement to the prior art.

According to one aspect of the present invention, an electronic device is provided. The electronic device is coupled to an external storage device, and the external storage device stores a boot code of the electronic device. The electronic device includes a memory, a storage control circuit, and a computing circuit. The storage control circuit is configured to read a first segment of the boot code from the external storage device and write the first segment of the boot code into a memory block of the memory. The first segment of the boot code includes a target code. The computing circuit is configured to execute the target code in the memory block in response to an interrupt.

According to another aspect of the present invention, an operation method of an electronic device is provided. The electronic device is coupled to an external storage device and includes a memory, and the external storage device stores a boot code of the electronic device. The method includes the following steps: (A) writing a first segment of the boot code into a memory block of the memory; (B) executing a part of the first segment of the boot code; and (C) executing a target code in the memory block in response to an interrupt.

According to still another aspect of the present invention, an electronic device is provided. The electronic device is coupled to an external storage device, and the external storage device stores a boot code of the electronic device. The electronic device includes a memory, a storage control circuit, and a computing circuit. The storage control circuit is configured to read a first segment of the boot code from the external storage device and write the first segment of the boot code into a memory block of the memory. The computing circuit is configured to execute a second segment of the boot code and detect whether a target command is received while executing the second segment of the boot code. The target command controls the computing circuit to execute a target code in the memory block.

The technical means embodied in the embodiments of the present invention can solve at least one of the problems of the prior art. Therefore, compared to the prior art, the present invention can execute the source code that needs to be protected earlier.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a schematic diagram of a conventional boot flow of an electronic device running a Linux system.

FIG. 2 is a functional block diagram of an electronic device according to an embodiment of the present invention.

FIG. 3 is a schematic diagram of the boot code of the present invention.

FIG. 4 shows a schematic diagram of the Miniboot code according to an embodiment of the present invention.

FIG. 5 is a flowchart of an operation method of an electronic device according to an embodiment of the present invention.

FIG. 6 shows a schematic diagram of data exchange between the target code and the U-boot code according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an electronic device and an operation method thereof. On account of that some or all elements of the electronic device could be known, the detail of such elements is omitted provided that such detail has little to do with the features of this disclosure, and that this omission nowhere dissatisfies the specification and enablement requirements. Some or all of the processes of the operation method may be implemented by software and/or firmware and can be performed by the electronic device or its equivalent. A person having ordinary skill in the art can choose components or steps equivalent to those described in this specification to carry out the present invention, which means that the scope of this invention is not limited to the embodiments in the specification.

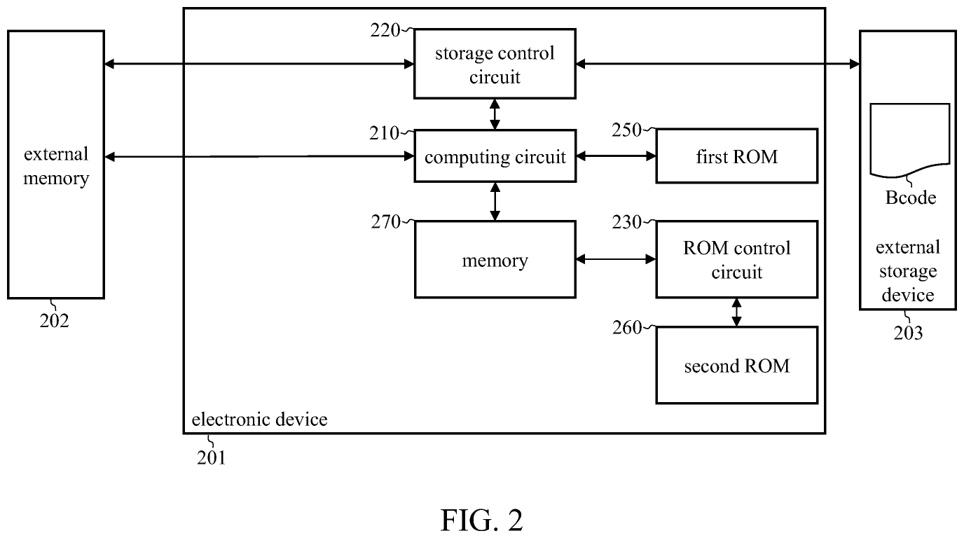

FIG. 2 is a functional block diagram of an electronic device according to an embodiment of the present invention. The electronic device 201 is coupled to an external memory 202 (e.g., a dynamic random access memory (DRAM)) and an external storage device 203 (e.g., a flash memory, embedded multimedia card (eMMC), or secure digital (SD) memory card). The external storage device 203 stores the boot code Bcode of the electronic device 201 (i.e., the firmware associated with the booting of the electronic device 201). The boot code Bcode is encrypted to prevent tampering or theft. Since the encryption operation and decryption operation of the boot code Bcode are well known to people having ordinary skill in the art and are not the focus of the present invention, the encryption operation and decryption operation will be omitted from the following discussion.

The electronic device 201 includes a computing circuit 210, a storage control circuit 220, a read-only memory (ROM) control circuit 230, a first ROM 250, a second ROM 260, and a memory 270 (e.g., a static random access memory (SRAM)). In one embodiment, the electronic device 201 is formed by a chip in which the computing circuit 210, the storage control circuit 220, the ROM control circuit 230, the first ROM 250, the second ROM 260, and the memory 270 are disposed, while the external memory 202 and the external storage device 203 are each formed by a separate chip.

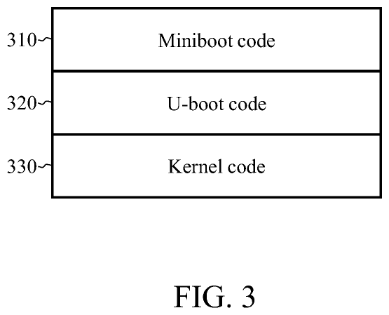

FIG. 3 is a schematic diagram of the boot code Bcode of the present invention. The boot code Bcode includes three segments: the Miniboot code 310 (the first segment), the U-boot code 320 (the second segment), and the Kernel code 330 (the third segment). Before the electronic device 201 boots up, the boot code Bcode is stored in the external storage device 203. When the electronic device 201 is booting up, the storage control circuit 220 reads the Miniboot code 310 from the external storage device 203 and stores the Miniboot code 310 in the memory 270 to be executed by the computing circuit 210. For the U-boot code 320, the storage control circuit 220 stores the U-boot code 320 in the memory 270 or the external memory 202 to be executed by the computing circuit 210. For the Kernel code 330, the storage control circuit 220 usually stores the Kernel code 330 in the external memory 202 to be executed by the computing circuit 210.

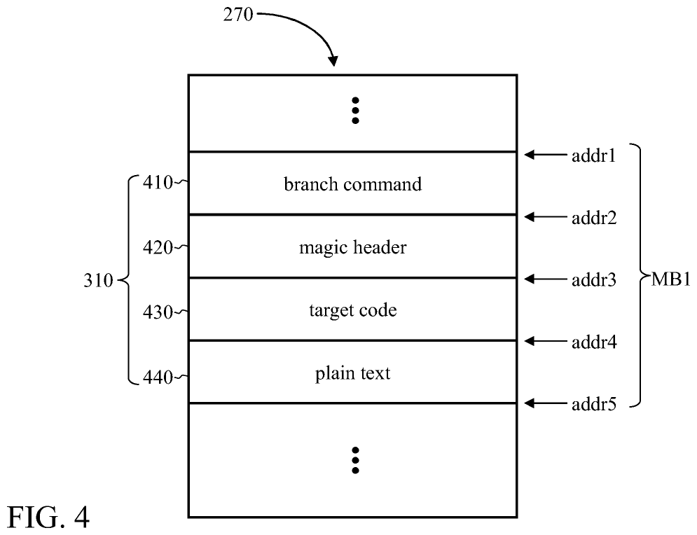

FIG. 4 shows a schematic diagram of the Miniboot code 310 according to an embodiment of the present invention. The Miniboot code 310 (i.e., the first segment of the boot code Bcode) includes a branch command 410, a magic header 420, a target code 430, and a plain text 440. When the Miniboot code 310 is stored in the memory 270, the Miniboot code 310 is stored in the memory block MB1 of the memory 270. More specifically, the starting addresses of the branch command 410, the magic header 420, the target code 430, and the plain text 440 in the memory 270 are the address addr1, the address addr2, the address addr3, and the address addr4, respectively. The address addr5 is the end address of the plain text 440. In other words, the starting address and end address of the memory block MB1 are the address addr1 and the address addr5, respectively. The core or main program code of the Miniboot code 310 is stored in plain text 440.

Because the sizes of the branch command 410, the magic header 420, the target code 430, and the plain text 440 can be known in advance, and the location of the memory block MB1 in the memory 270 can also be determined in advance, the address addr3 can be known and written in the U-boot code 320 in advance. In some embodiments, the sizes of the branch command 410 and the magic header 420 are fixed.

Reference is made to FIGS. 2 to 4. The starting address of the plain text 440 (i.e., the address addr4) is stored in the branch command 410. When executing the Miniboot code 310, the computing circuit 210 first obtains the address addr4 from the branch command 410 and then reads and executes the plain text 440 according to the address addr4. Refer to the lds document of the Miniboot for storing the starting address of the plain text 440 in the branch command 410.

The target code 430 is associated with a specific application provided by the manufacturer or developer of the electronic device 201. For example, the specific application may assist a third party in burning confidential data into the second ROM 260 or in inspecting the electronic device 201. Note that because the target code 430 is arranged in the Miniboot code 310, the target code 430 is also protected by encryption (i.e., cannot be tampered with or stolen).

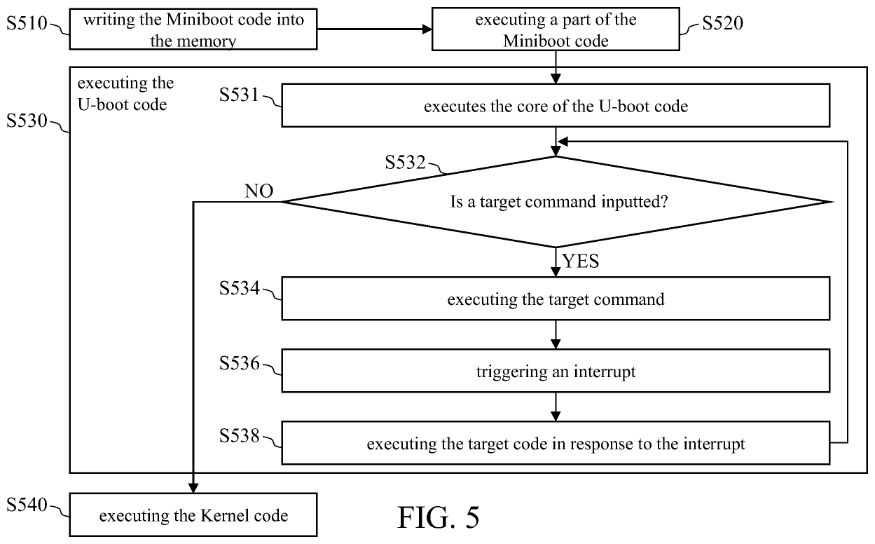

FIG. 5 is a flowchart of an operation method of the electronic device according to an embodiment of the present invention. The flowchart includes the following steps.

Step S510: The storage control circuit 220 reads the Miniboot code 310 from the external storage device 203 and writes the Miniboot code 310 into the memory 270 through the computing circuit 210. FIG. 4 shows an example of the Miniboot code 310 stored in the memory 270.

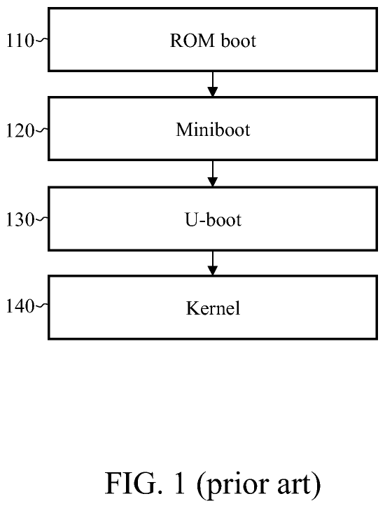

Step S520: The computing circuit 210 executes a part of the Miniboot code 310 that is stored in the memory 270. More specifically, in this step, the computing circuit 210 first reads the branch command 410 to obtain the starting address (the address addr4) of the plain text 440, and then reads and executes the program code in the plain text 440 according to the starting address. The execution details of this step are the same as the execution of the conventional Miniboot 120 (FIG. 1), so the details are thus omitted for brevity. Note that the computing circuit 210 does not execute the target code 430 in step S520.

Step S530: The computing circuit 210 executes the U-boot code 320, including sub-steps S531, S532, S534, S536, and S538.

Step S531: The computing circuit 210 executes the core or main part of the U-boot code 320. This step is similar to the execution of the conventional U-boot 130 (FIG. 1), so the details are omitted for brevity.

Step S532: The computing circuit 210 detects whether a target command is received. More specifically, a command line is provided during the execution of the U-boot for the users or operators to input commands. The aforementioned third party can input the target command associated with the execution of the target code 430 through the command line (e.g., a developer-defined command “otpctrl”). When the computing circuit 210 detects the input of the target command (the result of step S532 is YES), the computing circuit 210 executes the target command (step S534); otherwise, the computing circuit 210 executes the Kernel code 330 (step S540).

Step S534: The computing circuit 210 executes the target command. When executing the target command, the computing circuit 210 enters an encapsulation function having a software interrupt (SWI) and then executes the SWI.

Step S536: Following step S534, the computing circuit 210 triggers the interrupt and interrupts the execution of the U-boot code 320. The triggering of SWIs is well known to people having ordinary skill in the art, so the details are thus omitted for brevity.

Step S538: Following step S536, the computing circuit 210 executes the target code 430 in response to the interrupt. More specifically, the exception interrupt vector table in the U-boot code 320 specifies the interrupt service routine (ISR) of the SWI. In the ISR, according to the address addr3 (i.e., the starting address of the target code 430) stored in the U-boot code 320, the computing circuit 210 uses the function pointer to jump to the address addr3 of the memory 270 (i.e., to point the function pointer to the address addr3), and then execute the target code 430 in the memory block MB1. After executing the target task of the target code 430 (i.e., the aforementioned specific application), the computing circuit 210 executes the unexecuted part of the U-boot code 320 and continues to detect whether the target command is received (S532). If the computing circuit 210 receives no further target command and the execution of the U-boot code 320 is completed, the computing circuit 210 ends the step S530. In some embodiments, the computing circuit 210 saves the current stack before executing the target code 430 and restores the stack after the execution is completed.

Note that steps S532, S534, S536, and S538 are executed in step S530. In other words, the computing circuit 210 performs steps S532, S534, S536, and S538 before the execution of the U-boot is completed (i.e., before performing step S540).

Step S540: The computing circuit 210 executes the Kernel code 330. The execution details of this step are the same as the execution of the conventional Kernel 140 (FIG. 1), so the details are thus omitted for brevity.

To sum up, because the target code 430 is arranged in the Miniboot code 310, the execution of the target code 430 by the third party can be advanced in the execution of the U-boot. Compared to the prior art in which the target code 430 is executed in the form of a library in the Kernel, the present invention can save time. In one application scenario, the third party burns the key used to decrypt the boot code Bcode and/or its hash value into the second ROM 260 by executing the target code 430 during the production and deployment of the electronic device 201. Therefore, the present invention enables the third party to reduce the time for production and deployment, thereby increasing productivity.

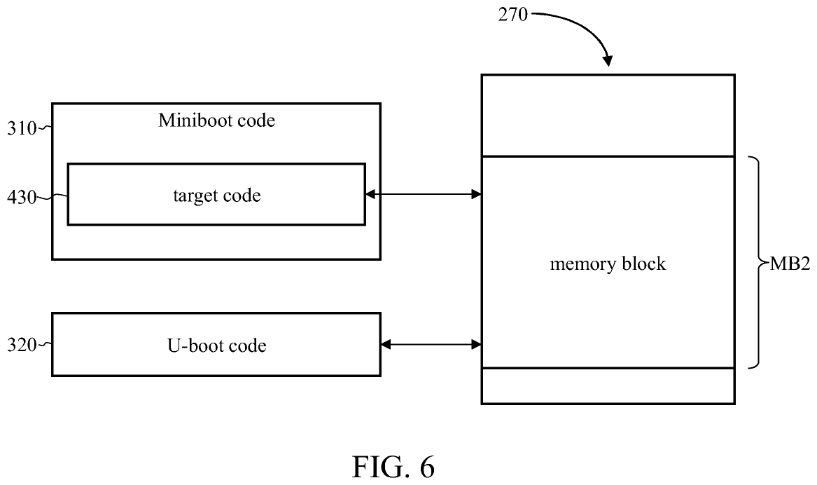

FIG. 6 shows a schematic diagram of data exchange between the target code and the U-boot code according to an embodiment of the present invention. The target code 430 and the U-boot code 320 can exchange data through the memory block MB2 pre-allocated in the memory 270. More specifically, the target code 430 and the U-boot code 320 can agree in advance on the data format and the location in the memory 270 for storing the data, so that the target code 430 can write the state of the target task (e.g., whether it is successfully executed) into the memory block MB2, and the U-boot code 320 reads the state from the memory block MB2 and then notifies the user of the state through the user interface (e.g., a display). Because the data is exchanged through the memory block MB2, the size of the data exchanged is not limited by the function. In some embodiments, the memory block MB2 and the memory block MB1 in FIG. 4 are different memory blocks.

The computing circuit 210 may be a circuit or an electronic component capable of executing programs, such as a central processing unit (CPU), a microprocessor, a microcontroller, a micro-processing unit, a digital signal processor (DSP), or its equivalent circuit. In other embodiments, people having ordinary skill in the art can design the computing circuit 210 according to the disclosure above, that is, the computing circuit 210 can be an application specific integrated circuit (ASIC) or can be embodied by circuits or hardware such as a programmable logic device (PLD).

The burning process of the ROM is intended to illustrate the target task (specific application) by way of example and not to limit the scope of the claimed invention. People having ordinary skill in the art may apply the present invention to other tasks or applications in accordance with the foregoing discussions.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An electronic device, wherein the electronic device is coupled to an external storage device, and the external storage device stores a boot code of the electronic device, the electronic device comprising:
a memory;
a storage control circuit configured to read a first segment of the boot code from the external storage device and write the first segment of the boot code into a memory block of the memory, wherein the first segment of the boot code comprises a target code; and
a computing circuit configured to execute the target code in the memory block in response to an interrupt.

2. The electronic device of claim 1, wherein the boot code further comprises a second segment, and the interrupt is generated while the computing circuit is executing the second segment of the boot code.

3. The electronic device of claim 2, wherein the computing circuit detects whether a target command triggering the interrupt is received while executing the second segment of the boot code.

4. The electronic device of claim 2, wherein the first segment of the boot code comprises a Miniboot code of a Linux system, and the second segment of the boot code comprises a U-boot code of the Linux system.

5. The electronic device of claim 4, wherein the memory block is a first memory block, the memory further comprises a second memory block, and the target code and the U-boot code exchange data through the second memory block when executed.

6. The electronic device of claim 1, wherein the electronic device further comprises a read-only memory (ROM), and the target code is associated with a burning process of the ROM.

7. The electronic device of claim 1, wherein the first segment of the boot code comprises a Miniboot code of a Linux system, the Miniboot code comprises a branch command and a plain text, and the target code is stored between the branch command and the plain text in the memory.

8. An operation method of an electronic device, wherein the electronic device is coupled to an external storage device and comprises a memory, and the external storage device stores a boot code of the electronic device, the method comprising:
(A) writing a first segment of the boot code into a memory block of the memory;
(B) executing a part of the first segment of the boot code; and
(C) executing a target code in the memory block in response to an interrupt.

9. The method of claim 8 further comprising:
(D) executing a second segment of the boot code after step (A);
wherein step (C) occurs during step (D).

10. The method of claim 9 further comprising:
(E) detecting whether a target command triggering the interrupt is received in step (D).

11. The method of claim 9, wherein the first segment of the boot code comprises a Miniboot code of a Linux system, and the second segment of the boot code comprises a U-boot code of the Linux system.

12. The method of claim 11, wherein the memory block is a first memory block, the memory further comprises a second memory block, and the target code and the U-boot code exchange data through the second memory block when executed.

13. The method of claim 8, wherein the electronic device further comprises a read-only memory (ROM), and the target code is associated with a burning process of the ROM.

14. The method of claim 8, wherein the first segment of the boot code comprises a Miniboot code of a Linux system, the Miniboot code comprises a branch command and a plain text, and the target code is stored between the branch command and the plain text in the memory.

15. An electronic device, wherein the electronic device is coupled to an external storage device, and the external storage device stores a boot code of the electronic device, the electronic device comprising:
a memory;
a storage control circuit configured to read a first segment of the boot code from the external storage device and write the first segment of the boot code into a memory block of the memory; and
a computing circuit configured to execute a second segment of the boot code and detect whether a target command is received while executing the second segment of the boot code;
wherein the target command controls the computing circuit to execute a target code in the memory block.

16. The electronic device of claim 15, wherein the first segment of the boot code comprises a Miniboot code of a Linux system, and the second segment of the boot code comprises a U-boot code of the Linux system.

17. The electronic device of claim 16, wherein the computing circuit executes the target code before finishing executing the U-boot code.

18. The electronic device of claim 16, wherein the memory block is a first memory block, the memory further comprises a second memory block, and the target code and the U-boot code exchange data through the second memory block when executed.

19. The electronic device of claim 15, wherein the electronic device further comprises a read-only memory (ROM), and the target code is associated with a burning process of the ROM.

20. The electronic device of claim 15, wherein the first segment of the boot code comprises a Miniboot code of a Linux system, the Miniboot code comprises a branch command and a plain text, and the target code is stored between the branch command and the plain text in the memory.
